(19) United States
(12) Patent Application Publication
(10) Pub. No.: US 2012/0169467 A1
(43) Pub. Date: Jul. 5, 2012

(54) PATIENT ALERT MANAGEMENT SYSTEM

(76) Inventor: David L. Condra, Nashville, TN (US)

(21) Appl. No.: 13/340,044

(22) Filed: Dec. 29, 2011

Related U.S. Application Data
(60) Provisional application No. 61/428,948, filed on Dec. 31, 2010.

(51) Int. Cl. G08B 5/22

(52) U.S. Cl. 340/8.1

(57) ABSTRACT

A patient alert management system includes a remote alert monitor at a location, an alert management and reporting server, and a portable communications device. The remote alert monitor generates an alert in response to an internal patient care timer or receiving an alert from a patient care device at the location of the remote alert monitor and communicates the alert to the alert management and reporting server. The alert management and reporting server sends a message to the portable communications device including a description of the alert and the location. The portable communications device displays the description and location to a caregiver. The caregiver goes to the location and cancels the alert via the remote alert monitor. The remote alert monitor sends an alert cancellation to the alert management and reporting server in the alert management and reporting server cancels the alert in response to receiving the alert cancellation.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application which is hereby incorporated by reference in its entirety: U.S. Provisional Patent Application No. 61/428,948, filed Dec. 31, 2010 entitled “REMOTE MONITORING SYSTEM FOR HOSPITAL PATIENTS.”

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to systems, methods and devices for monitoring hospital patients electronically and for managing alerts generated by patient care devices. More particularly, the invention relates to systems and methods for ensuring that appropriate caregivers receive each alert and that a caregiver physically appears at the location of the alert to cancel the alert.

There are multiple, disparate nurse call systems, hospital information management systems, alert or alarm standards for patient care devices, and caregiver paging systems. With the myriad patient care devices (e.g., drug pumps, food pumps, blood pressure monitors, pulse/oxygen monitors, pressure pads, etc.) used in each patient room, caregivers suffer from alarm (i.e., alert) fatigue and confusion. It is often difficult to determine exactly which location (e.g., room) an alarm is emanating from and what the alarm means. Thus, it is hard to determine whether a single caregiver or multiple caregivers, and what type of caregivers are needed at the location. For example, one nurse may be needed to replace an empty IV fluid bag while at least two caregivers (i.e., nurses, nurse assistants, or doctors) are needed to turn or move a patient.

Additionally, paper charts are still the dominant method of tracking and managing caregiver responsibility and performance. Unfortunately, these records are often incomplete, inaccurate, or falsified to show that care was provided to a patient when in fact, no care, or inappropriate care was provided. Frequently, items like checking whether pain medication is sufficient one hour after administration and turning patients at a set interval are not performed consistently. Further, it is difficult to gather performance statistics from these charts for analyzing care efficiencies in the hospital or caregiving facility or for analyzing patient data for indications of certain medical conditions.

Existing methods of communication between caregivers are also noisy and unidirectional. When healthcare staff (e.g., a nurse or secretary at a nursing station or caregiver station) receives a call from a patient, a caregiver is typically summoned via an overhead paging system. The healthcare staff at the nursing station has no way of knowing whether the intended caregiver has received the page and when or if the caregiver attended to the patient's need.

### BRIEF SUMMARY OF THE INVENTION

In one aspect of the invention, a remote alert monitor for use in a patient alert management system having an alert management and reporting server and at least one patient care device at a location associated with the remote alert monitor includes a processor, a patient care device interface, a server interface, and a user interface. The processor receives an alert and communicates the received alert. The patient care device interface is functionally coupled to the processor in the patient care device at the location. The patient care device interface receives the alert from the patient care device and communicates the received alert to the processor. The server interface is coupled to the processor and communicates the alert received via the patient care device interface to the alert management and reporting server in response to receiving the alert. The user interface is coupled to the processor and receives input from a user to cancel the alert and communicates the received input to the processor. In response to receiving the input to cancel the alert from the user interface, the processor communicates an alert cancellation to the alert management and reporting server via the server interface indicating the alert and the location associated with the remote alert monitor.

In another aspect, a remote alert monitor for use in a patient alert management system has an alert management and reporting server including a processor, a server interface, and a user interface. The processor is operable to receive the alert. The server interface is coupled to the processor and receives the alert from the alert management and reporting server and provides the received alert to the processor. The user interface is coupled to the processor and receives input from a user to cancel the alert and to communicate the received input to the processor. In response to receiving the input to cancel the alert from the user interface, the processor communicates an alert cancellation to the alert management and reporting server via the server interface indicating the alert and a location associated with the remote alert monitor.

In another aspect, a remote alert monitor for use in a patient alert management system having an alert management and reporting server includes a patient care timer, a processor, a server interface, and a user interface. The patient care timer generates an alert after a predetermined amount of time. The processor is coupled to the patient care timer and receives the alert generated by the patient care timer and communicates the received alert. The server interface is coupled to the processor and communicates the alert to the alert management and reporting server in response to receiving the alert from the processor. The user interface is coupled to the processor to receive input from a user to cancel the alert and communicates the received input to the processor. In response to receiving the input to cancel the alert from the user interface, the processor communicates an alert cancellation to the alert management and reporting server via the server interface indicating the alert and a location associated with the remote alert monitor.

In another aspect, an alert management and reporting server for use in a patient alert management system includes a communications interface, a memory, and a processor. The patient alert management system includes a remote alert monitor at a location and a display. The communications interface receives an alert and the location from the remote alert monitor. The memory receives and stores the alert and the location. The processor enters the alert received by the communications interface and the memory, linking the entered alert with the location and identifying the alert as active. The processor further communicates a table of active alerts entered in the memory to the display of the patient alert management system.

In another aspect, an alert management and reporting server for use in a patient alert management system includes a communications interface, a memory, and a processor. The patient alert management system includes a remote alert monitor at a location. The communications interface is operable to receive an alert and the location from the remote alert monitor. The memory is operable to receive and store the alert, the location, and a status of the alert. The processor is operable to enter the alert received by the communications interface in the memory such that the entered alert is linked with the location and identified as active. The processor is further operable to cancel the alert stored in the memory only in response to receiving an alert cancellation from the remote alert monitor at the location.

In another aspect, an alert management and reporting server for use in a patient alert management system includes a communications interface, a memory, and a processor. The patient alert management system includes a remote alert monitor at a location. The communications interface is operable to receive alert and the location from the remote alert monitor. The memory is operable to receive and store the alert and the location and to link the location with a portable communications device identifier. The processor is operable to enter the alert received by the communications interface in the memory such that the entered alert is linked with the location and identified as active. The processor is further operable to retrieve the portable communications device identifier linked with the location from the memory, send a message to a portable communications device associated with the portable communications device identifier via the communications interface, and receive an acknowledgment via the communications interface from the portable communications device associated with the portable communications device identifier. The message includes the location and the alert, and the acknowledgment indicates acceptance or rejection of the alert in the message.

In another aspect, a portable communications device for use in a patient alert management system includes a processor, a communications interface, a display, and a user interface. The patient alert management system includes an alert management and reporting server. The processor is operable to receive a message and communicate the received message. The communications interface is operable to receive the message comprising an alert and a location from the alert management and reporting server. The communications interface is further operable to communicate the received message to the processor, receive an acknowledgment from the processor, and communicate the received acknowledgment to the alert management and reporting server. The display is operable to receive the alert and location from the processor and display the received alert and location to a user of the portable communications device. The user interface is operable to receive a response from a user of the portable communications device. The response includes an acceptance or a rejection of the alert in the message. The user interface is further operable to communicate the received response to the processor. The processor is further operable to communicate the acknowledgment to the alert management and reporting server via the communications interface as a function of and in response to receiving the response from the user interface.

In another aspect, a display for use in a patient alert management system includes a screen. The screen is functional to display a dynamic table of active alerts. The dynamic table of active alerts includes a plurality of entries. Each entry includes a description, a location, and an elapsed time. The description identifies a cause of an alert corresponding to the entry or an action to be taken in response to the alert corresponding to the entry. The location is a location associated with the alert corresponding to the entry. The elapsed time is an elapsed time associated with the entry.

In another aspect, a patient alert management system includes a remote alert monitor, an alert management and reporting server, and a portable communications device. The remote alert monitor is operable to communicate an alert. The alert management and reporting server is operably coupled to the remote alert monitor and is operable to receive the alert communicated by the remote alert monitor. The alert management and reporting server is further operable to send a message including the alert and a location linked to the alert to a portable communications device identifier linked to the location in response to receiving the alert from a remote alert monitor or at least one client computing device operable to receive information from healthcare staff. The portable communications device is operable to receive the message sent to the portable communications device identifier, display the received alert and location to a user of the portable communications device, receive an acknowledgment from the user, and communicate the received acknowledgment to the alert management and reporting server.

In another aspect, a patient alert management system includes a remote alert monitor, an alert management and reporting server, and a portable communications device. The remote alert monitor is operable to communicate an alert, receive an alert cancellation from a caregiver at a location of the remote alert monitor, and communicate the received alert cancellation. The alert management and reporting server is operably coupled to the remote alert monitor. The alert management and reporting server is operable to receive the alert provided by the remote alert monitor and send a message that includes the alert and a location linked to the alert to a portable communications device identifier linked to the location in response to receiving the alert from the remote alert monitor. The alert management and reporting server is further operable to receive the alert cancellation from the remote alert monitor and cancel the alert in response to receiving the alert cancellation from the remote alert monitor. The portable communications device is operably coupled to the alert management and reporting server. The portable communications device is operable to receive the message sent to the portable communications device identifier by the alert management and reporting server and to display the received alert and location to a user of the portable communications device.

In another aspect, a method of managing alerts and a patient alert management system includes receiving an alert communicated to a remote alert monitor of the patient alert management system. The patient alert management system includes the remote alert monitor which is associated with a location and an alert management and reporting server. The remote alert monitor communicates the alert and the location to the alert management and reporting server. A description of the alert and the location associated with the remote alert monitor is displayed to a caregiver. Input is received from the caregiver at the remote alert monitor via a user interface of the remote alert monitor. The remote alert monitor communicates an alert cancellation to the alert management and reporting server in response to receiving the input from the caregiver at the remote alert monitor.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various drawings unless otherwise specified.

FIG. 1 is a block diagram of a patient alert management system.

FIG. 2 is a block diagram of a remote alert monitor for use in the patient alert management system of FIG. 1.

FIG. 3 is a block diagram of an alert management and reporting server for use in the patient alert management system of FIG. 1.

FIG. 4 is a block diagram of a portable communications device for use in the patient alert management system of FIG. 1.

FIG. 5 is a block diagram of a display for use in the patient alert management system of FIG. 1.

FIG. 6 is a flowchart of a method for managing alerts and a patient alert management system.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

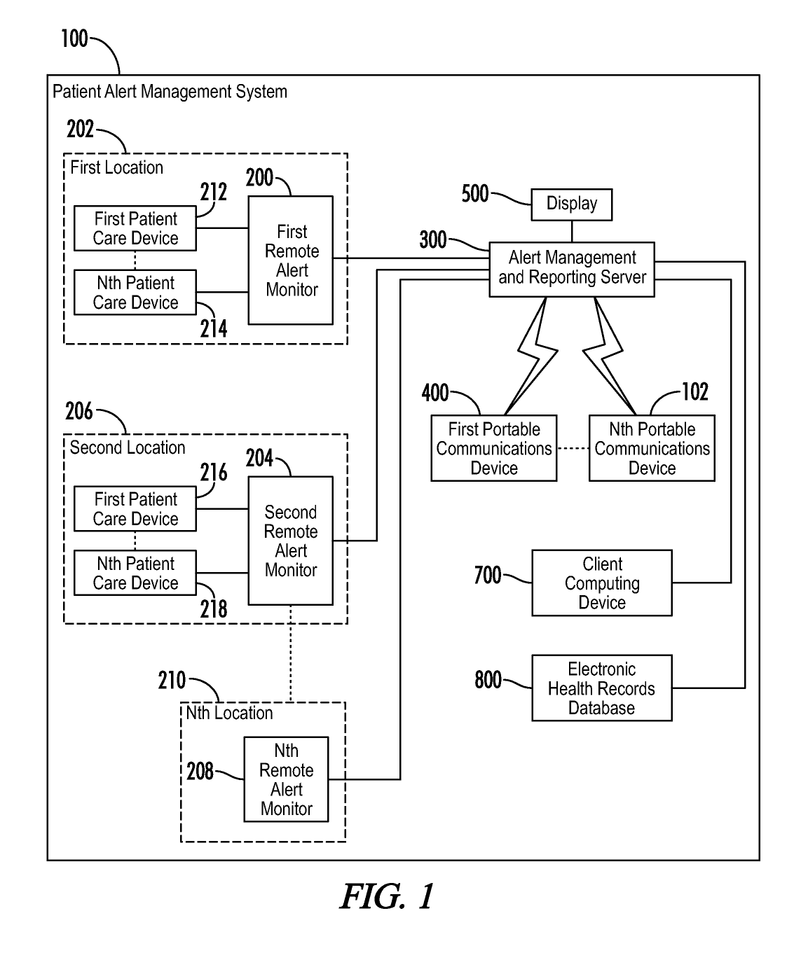

Referring to FIG. 1, a patient alert management system 100 includes a plurality of remote alert monitors, a plurality of portable communications devices, an alert management and reporting server 300, and at least one display 500. The patient alert management system 100 may be used in, for example, a hospital, nursing home, a physical therapy facility, or any other facility where each of a limited number of caregivers is tending to the needs of multiple patients. It is also contemplated that a single alert management and reporting server 300 may provide service to more than one facility (e.g., one alert management and reporting server 300 per healthcare campus). In such an embodiment, the patient alert management system 100 could include a display 500 at each caregiver station (e.g., nurses' station), administration center, and/or facility.

The plurality of remote alert monitors includes a first remote alert monitor 200 at a first location 202 associated with the patient alert management system 100, a second remote alert monitor 204 at a second location 206 associated with the patient alert management system 100, and an n^{th} remote alert monitor 208 at an n^{th} location 210 associated with the patient alert management system 100. In one embodiment, a location such as the first location 202 may include a communications address or identifier (e.g., an internet protocol address) and a physical location (e.g., a room having an associated room number). At the first location 202 (i.e., in a room associated with the first remote alert monitor 200), a first patient care device 212 interfaces with the first remote alert monitor 200 to provide alerts to the first remote alert monitor 200 as indicated by a function of the first patient care device 212, and an n^{th} patient care device 214 interfaces with the first remote alert monitor 200 to provide alerts to the first remote alert monitor 200 as indicated by a function of the n^{th} patient care device 214.

For example, in one embodiment, the first patient care device 212 is an IV pump. When the IV pump 212 determines that a reservoir of the IV pump 212 is empty or has a low battery, the IV pump 212 provides an alert to the first remote alert monitor 200. In one embodiment, the IV pump 212 is coupled via a wired interface or wireless interface to the first remote alert monitor 200. The alert describes the cause of the alert. In another example, the n^{th} patient care device 214 is a pressure pad. The pressure pad 214 detects the presence of a patient on the pad, and when the pressure pad 214 detects that the patient is lifting from or off of the pressure pad 214, the pressure pad 214 sends an alert to the first remote alert monitor 200. The second remote alert monitor 204 at the second location 206 includes a plurality of associated patient care devices at the second location 206. The plurality of associated patient care devices at the second location 206 includes a first patient care device 216 through and an n^{th} patient care device 218. In one embodiment, an alert can only be canceled from the patient alert management system 100 at the remote alert monitor that generated the alert.

Additionally, as shown by the n^{th} remote alert monitor 208 at the n^{th} location 210, a remote alert monitor may be used in the patient alert management system 100 without any associated patient care devices. In such an embodiment, the n^{th} remote alert monitor 208 may receive and communicate alerts in the form of messages to staff (i.e., similar to existing nurse call systems) or from an internal patient care timer of the n^{th} remote alert monitor 208.

The plurality of portable communications devices includes a first portable communications device 400 through an n^{th} portable communications device 102. Each caregiver carries a portable communications device associated with the caregiver in the alert management and reporting server 300. When the alert management and reporting server 300 receives an alert from a remote alert monitor of the patient alert management system 100, the alert management and reporting server 300 sends a message to an appropriate caregiver via the caregiver's portable communication device.

The patient alert management system 100 may optionally include a client computing device 700 and an electronic health records database 800. The client computing device 700 may be an existing computing device and a caregiver station or admissions desk having a computer application program to interface with the alert management and reporting server 300 via an existing communications infrastructure (e.g., a local area network) in a patient care facility. The client computing device 700 can be used to enter information and alerts into the alert management and reporting server 300. The electronic health records database 800 may be part of the patient alert management system 100 or part of an existing information infrastructure of the patient care facility. The alert management and reporting server 300 interfaces with electronic health records database 800 to determine patient risk profiles for various conditions and set care parameters such as patient care timers for each patient. For example, the alert management and reporting server 300 may determine that a patient has advanced diabetes and set patient care timers at appropriate intervals for blood sugar checks in a remote alert monitor associated with the patient. The alert management and reporting server 300 may also determine that a patient is at high risk for developing skin ulcers and sets patient care timers at appropriate intervals for turning the patient.

The alert management and reporting server 300 may also determine that the risk profile indicates a particular patient care device. For example, the risk profile may indicate that the patient is at a high risk for falling which indicates that the patient should be on a pressure pad. The alert management and reporting server 300 sends a command to the remote alert monitor associated with the patient to check for a connected pressure pad, causing the remote alert monitor to provide an alarm if a pressure pad is not connected to the remote alert monitor.

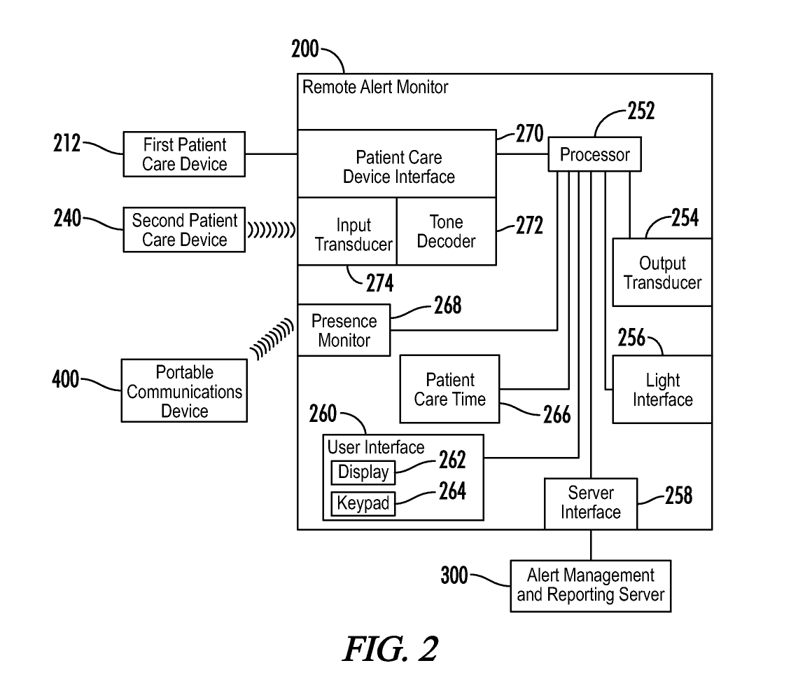

Referring to FIG. 2, the first remote alert monitor 200 shown in FIG. 1 includes a patient care device interface 270, a processor 252, and a server interface 258. The first patient care device 212 is operably connected to the patient care device interface 270 via a wired connection and corresponding data cable, such as a local area network, a serial port, a USB port, or a proprietary interface. The connection may also be wireless, such as in a wireless local area network (e.g., Wi-Fi). When the patient care device interface 270 receives an alert from the first patient care device 212 via the connection, the patient care device interface 270 provides the received alert to the processor 252.

A second patient care device 240 is operably connected to the remote alert monitor 200 via an audible link. That is, when the second patient care device 240 generates an alert, the second patient care device 240 provides an audible indicator or alarm (i.e., sound) corresponding to the generated alert. The patient care device 270 includes an input transducer 274 and a tone decoder 272. The input transducer 274 (e.g., a microphone) receives the sound provided by the second patient care device 240 and provides a signal indicative of the received sound to the tone decoder 272. The tone decoder 272 receives the signal indicative of the received sound, determines whether the received signal corresponds to a predefined alarm tone, and provides an alert to the processor 252 if the received signal corresponds to the predefined alarm tone.

The tone decoder 272 is operable to determine that the received signal corresponds to one of a plurality of alarm tones and communicate an alert to the processor 252 indicative of the corresponding alarm tone. In one embodiment, the processor 252 delays or cancels an alert if the alert is an alert received from the tone decoder 272 within a predetermined period of time of another alert received via the tone decoder 272. Additionally or alternatively, the alert management and reporting server 300 may instruct the remote alert monitor 200 to ignore, cancel, or delay certain alerts corresponding to an audible alarm if an alert corresponding to the audible alarm has been received at the alert management and reporting server 300 within a predetermined period of time from a location near the first location 202 (i.e., the physical location) of the remote alert monitor 200. Ignoring, canceling, or delaying alerts at a particular remote alert monitor (e.g., remote alert monitor 200) may be done to, for example, reduce interference from audible alarm detection from the second location 206 when the second location 206 is near the first location 202 (i.e., the physical location of the remote alert monitor 200).

When the patient care device interface 270 receives an alert from a patient care device at a location associated with the remote alert monitor 200 (e.g., the first patient care device 212, or the second patient care device 240), the patient care device interface 270 provides the received alert to the processor 252. The processor 252 communicates each received alert to the alert management and reporting server 300 via the server interface 258. In one embodiment, the server interface 258 is a Wi-Fi module, or Ethernet module. The remote alert monitor 200 is also operable to receive alerts from the alert management and reporting server 300 via the server interface 258. For example, when a patient communicates with healthcare staff at a caregiver station via an existing nurse call system or an intercom function of the remote alert monitor 200, the healthcare staff at the caregiver station can enter an alert in the alert management and reporting server 300 via the client computing device 700. The entered alert would include a description entered by the healthcare staff at the caregiver station that is descriptive of the information provided to the healthcare staff at the caregiver station by the patient via the intercom function or existing nurse call system.

The remote alert monitor 200 also includes a user interface 260 including a display 262, and a user input device such as a keypad 264. In one embodiment, the display 262 lists active alerts associated with the remote alert monitor 200. A user (i.e., a caregiver) manipulates the keypad 264 to select an active alert shown on the display 262 and cancel the selected active alert. In one embodiment, the active alert to be canceled is selected from a list of alerts described in a list on an LCD screen by manipulating the keypad. In another embodiment, the active alert to be canceled is selected from a list of alerts described in a list on a touchscreen, and the alert to be canceled is selected via the touchscreen. In yet another embodiment, the active alert to be canceled is selected from a list of active alerts described in a list on the user interface 260 by illuminated LEDs behind a semi-transparent cover having alert descriptions. When an LED behind an alert description is illuminated, the user knows that the illuminated alert description is describing an active alert. The user selects the active alert by pressing the illuminated alert description, the alert description having a corresponding button of the keypad 264 behind it, and an alert cancellation button of the keypad 264. Alternatively, just pressing the illuminated alert description may initiate an alert cancellation. In response to receiving the input to cancel the alert from the user interface 260, the processor 252 communicates an alert cancellation to the alert management and reporting server 300 via the server interface 258. The alert cancellation indicates the selected alert to be canceled in the location associated with the remote alert monitor 200. Indicating the location associated with the remote alert monitor 200 may include communicating a network address of the remote alert monitor 200 and/or communicating a physical location of the remote alert monitor 200. In one embodiment, the user interface 260 is a touchscreen.

In one embodiment, the remote alert monitor 200 includes a presence monitor 268. The presence monitor 268 is operable to detect the presence of a caregiver identifier at the location of the remote alert monitor 200, read a code of the caregiver identifier, and provide the read code to the processor 252. The presence monitor 268 may include a radiofrequency identifier reader (RFID), infrared sensor, or ultrasound sensor. In one embodiment, a portable communications device such as the first portable communications device 400 is the caregiver identifier, and the code is a portable communications device identifier (e.g., a telephone number) associated with the first portable communications device 400. In another embodiment, the caregiver identifier is an employee identification badge, and the code is an employee number. In one embodiment, when a caregiver cancels an alert via the user interface 260, the processor 252 instructs the presence monitor 268 to read the caregiver identifier and provide the read code to the processor 252. When the processor 252 sends an alert cancellation corresponding to the canceled alert to the alert management and reporting server 300, the alert cancellation includes the read code.

In one embodiment, the remote alert monitor 200 also includes a patient care timer 266. The patient care timer 266 is operable to generate an alert after a predetermined amount of time and provide the generated alert to the processor 252. The processor 252 communicates the generated alert to the alert management and reporting server 300 via the server interface 258 as with alerts generated in other ways, such as by patient care devices. The predetermined amount of time may be indicated by a user activating the patient care timer 266 via the user interface 260 or indicated by the alert management and reporting server 300 when activating the patient care timer 266. The alert management and reporting server 300 activates the patient care timer 266 by sending a command to the remote alert monitor 200 indicating the predetermined amount of time and a description of the timer to be activated. The remote alert monitor 200 may simultaneously maintain a plurality of patient care timers 266. It is also contemplated that one or more patient care timers 266 may be embodied in the alert management and reporting server 300. In such an embodiment, a user activates the patient care timer 266 via the user interface 260, and the alert management and reporting server 300 provides an alert to the remote alert monitor 200 via the server interface 258 upon expiration of the predetermined amount of time.

Optionally, the remote alert monitor 200 includes an output transducer 254 and a light interface 256. In one embodiment, the patient care device (e.g., the first patient care device 212) is a pressure pad operable to generate a signal indicating whether a patient is in contact with the pressure pad. A pressure pad 212 is conventionally used for patients that are at risk for falling to notify caregivers that the patient is attempting to get out of a bed or out of a chair such that the caregivers can help the patient relocate and prevent any falls during the process. The pressure pad 212 provides a digital or analog signal proportional to a weight on the pressure pad 212, or the pressure pad 212 provides a binary signal indicating whether a weight above a threshold is present on the pressure pad 212. The signal indicating whether the patient is in contact with the pressure pad 212 is provided to the processor 252 via the patient care device interface 270. The processor 252 provides an alert to the alert management and reporting server 300 via the server interface 258. In response to the signal from the pressure pad 212 indicating that the patient is not in functional contact with the pressure pad 212 (i.e., the patient is not sitting or lying on the pressure pad 212). If the signal from the pressure pad 212 indicates that the patient is in functional contact with the pressure pad 212 within a predetermined period of time of generating the alert, the processor 252 sends an alert cancellation corresponding to the alert to the alert management and reporting server 300. Thus, if a patient merely shifts their weight on the pressure pad 212, the alert is automatically canceled. Upon generation of the alert, the processor 252 may turn the lights on for a predetermined period of time in the location of the remote alert monitor 200 and the patient via the light interface 256, and provide an audible warning to the patient via the output transducer 254.

In one embodiment, the audible warning includes a verbal explanation of the alert. In one embodiment, the verbal explanation may be a customized voice recording stored by the processor 252. For example, elderly patients or patients suffering from dementia are often more responsive to verbal warnings or explanations from trusted relatives or friends such that a verbal warning or explanation recorded by the trusted friend or relative is more effective for getting the patient to follow instructions (e.g., to wait for help to move or relocate) than a generic verbal warning stored by the processor 252. In another embodiment, the audible warning is provided by a voice recording module having a second output transducer for receiving the verbal alert, a memory for storing a customized voice recording (i.e., the verbal alert received via the second output transducer), and a second output transducer for providing the verbal alert to the patient in response to a request from the processor 252. In this embodiment, changing the customized voice recording when changing patients at the first location 202 may simplified because the customized voice recording in the module may be changed without involvement of the processor 252.

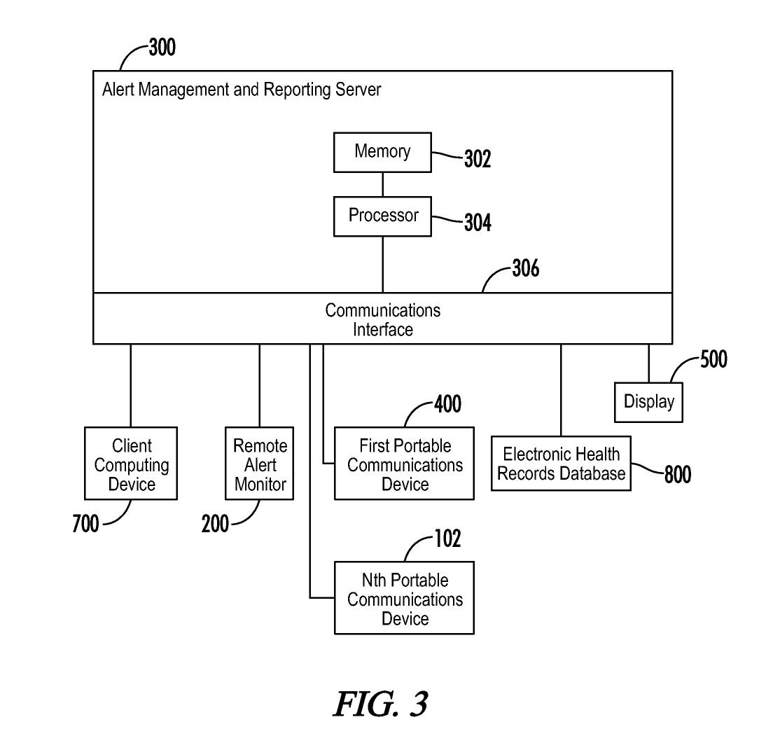

Referring to FIG. 3, the alert management and reporting server 300 includes a memory 302, a processor 304, and a communications interface 306. The communications interface 306 receives an alert and a location associated with the remote alert monitor 200 from the remote alert monitor 200 and provides the received alert and location to the processor 304. The processor 304 enters the alert in the memory 302, linking the entered alert with the location and identifying the alert as active. The processor 304 is also operable to communicate a table of active alerts entered in the memory 302 to the display 500 of the patient alert management system 100. In one embodiment, the alert management and reporting server 300 includes at least one computing device 700 operable to receive information from healthcare staff and at least one server 300 operable to store the information received from the healthcare staff. The information may include a patient risk profile and a location of a patient, and the client computing device 700 may receive and communicate an alert and associated location to the communications interface 306 of the alert management and reporting server 300.

The memory 302 also links each location with at least one portable communications device identifier (e.g., a phone number associated with the first portable communications device 400). This may be accomplished by directly linking each location with the portable communications device identifier, or by linking each location with a code corresponding to a caregiver and separately linking each caregiver code with a portable communications device identifier. Separately linking each caregiver code with a portable communications device identifier may enable caregivers to more easily exchange portable communications devices when, for example, a battery of a portable communications device is discharged. The processor 304 may change the caregiver linked to or assigned to a location or patient in the memory 302. The memory 302 may also link a patient risk profile with a location or a patient. The memory 302 stores and alert cancellations or alerts identified as canceled for analysis. Such analysis may include performance metrics for healthcare staff and outcome metrics for patients.

In response to receiving an alert, the processor 304 is operable to send a message to each portable communications device or caregiver associated with the location via the communications interface 306. Each message may include the alert (e.g., a description associate with the alert), and the location linked to the alert. The processor 304 retrieves the portable communications device identifier linked with the location from the memory 302 and sends the message to the portable communications device associated with the retrieved portable communications device identifier. In one embodiment, the processor 304 also communicates a table of active alerts associated with a portable communications device identifier entered in the memory 302 to the portable communications device 400 associated with the portable communications device identifier. The table of active alerts operates to provide a personalized queue of tasks to a caregiver (i.e., healthcare staff) assigned the portable communications device 400.

In one embodiment, the processor 304 is operable to determine information including a patient risk profile for a patient from the electronic health records database 800 and to provide patient care data to the electronic health records database 800. The provided patient care data may include alerts associated with a patient and alert cancellations associated with the patient.

In one embodiment, the processor 304 identifies the second remote alert monitor 204 at the second location 206 as being proximate the first remote alert monitor 200 at the first location 202. This may be accomplished by, for example, comparing a room number associated with the first location 202 to a room number associated with the second location 206. When the processor 304 receives an alert from the second remote alert monitor 204, and the alert indicates that the alert was received by the second remote alert monitor 204 via an audible interface with the patient care device 216, the processor 304 sends an ignore command to the first remote alert monitor 200 via the communications interface 306. In response to receiving the ignore command, the first remote alert monitor 200 suspends detection of one or more predefined audible alarm tones either for a predetermined period of time or until the first remote alert monitor 200 receives a command from the alert management and reporting server 300 indicating that the remote alert monitor 200 should resume detection of predefined audible alarm tones. In one embodiment, the first remote alert monitor 200 ignores only predefined audible alarm tones corresponding to the predefined audible alarm tone or tones corresponding to the alert from the second remote alert monitor 204.

In one embodiment, the alert management and reporting server 300 cancels an active alert only in response to receiving an alert cancellation from the remote alert monitor that communicated the active alert to the alert management and reporting server 300. In another embodiment, the alert management and reporting server 300 cancels an active alert only in response to either receiving an alert cancellation from the remote alert monitor that communicated the active alert to the alert management and reporting server 300 or in response to an administrative override command. The administrative override command is distinguished from information or data entered by healthcare staff at the client computing device 700. That is, the administrative override command may only be entered by a manager or supervisor (e.g., a head nurse or a doctor). This prevents healthcare staff from falsifying healthcare staff performance data and medical records and ensures that each issue that arises for each patient is addressed in the patient's room by a qualified caregiver of the healthcare facility.

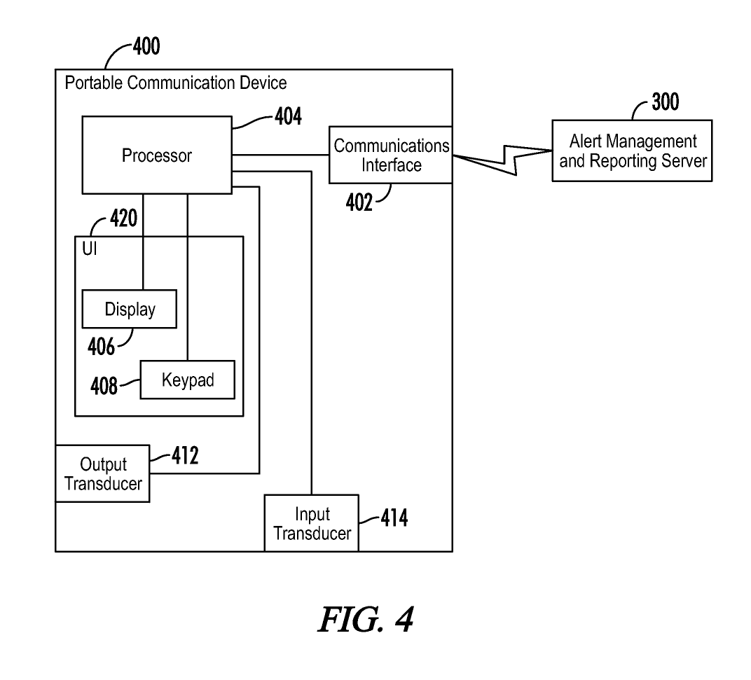

Referring to FIG. 4, the first portable communications device 400 includes a processor 404, a communications interface 402, a user interface 420, an output transducer 412 (e.g., a speaker), and an input transducer 414 (e.g., a microphone). In one embodiment, the user interface 420 includes a display 406 and a keypad 408. In another embodiment, the user interface 420 is a touchscreen display. In one embodiment, the display 406 is a liquid crystal display screen. The communications interface 402, input transducer 414, output transducer 412, and user interface 420 are operably coupled to the processor 404. The communications interface 402 communicates with the alert management and reporting server 300 by any wireless standard such as Wi-Fi, SMS, cellular telephone network (e.g., GSM or CDMA), cordless telephone network, DECT 6.0, or any number of other standards suitable to provide a unidirectional or bidirectional voice and/or data connection between the portable communications device 400 and the alert management and reporting server 300.

In one embodiment, the portable communications device 400 is operable to send an acknowledgment to the alert management and reporting server 300. The alert management and reporting server 300 is operable to receive the acknowledgment from the first portable communications device 400. In response to receiving an alert, the alert management and reporting server 300 sends a message comprising the alert and an associated location to the first portable communications device 400. The first portable communications device 400 is linked in the memory 302 with the location via a portable communications device identifier (e.g., telephone number) of the first portable communications device 400. When the first portable communications device 400 receives the message from the alert management and reporting server 300 at the communications interface 402, the communications interface 402 provides the message to the processor 404. The processor 404 communicates a description of the alert in the message and the location to the user interface 420. The user interface 420 displays a description of the alert and the location of the alert on the display 406. In one embodiment, the processor 404 provides an audio signal to the output transducer 414 which provides an audible notice to the user of the portable communications device 400 as a function of the received audio signal. This audible notice serves to inform the user (i.e., the caregiver associated with the first portable communications device 400) that the user has a new task to perform. In one embodiment, the audio signal provided by the processor 404 as a function of a type of the alert of the received message. This allows the user to distinguish between emergencies or high-priority tasks and routine tasks to be performed. In one embodiment, the processor 404 communicates a notification to the alert management and reporting server 300 via the communications interface 402 when the received message is displayed on the display 406. The notification indicates that the message has been displayed on the display 406 such that the alert management and reporting server 300 is aware that the first portable communications device 400 has received the message.

The user interface 420 is operable to receive a response from the user of the portable communications device 400. The response may be an acceptance or rejection of the alert in the message. The user interface 420 communicates the received response to the processor 404, and the processor 404 generates an acknowledgment indicating acceptance or rejection of the alert in the message. The processor 404 communicates the generated acknowledgment to the alert management and reporting server 300 via the communications interface 402. In one embodiment, the user interface 420 is operable to display a plurality of descriptions of received alerts and their corresponding locations. The user selects one of the plurality of displayed descriptions and corresponding locations and indicates an acceptance or rejection of the selected alert via the keypad 408 or touch screen interface.

When the alert management and reporting server 300 receives an alert cancellation corresponding to an alert previously provided to the first portable communications device 400, the alert management and reporting server 300 sends a removal message to the first portable communications device 400. The removal message indicates the alert for which the corresponding alert cancellation has been received at the alert management and reporting server 300. The communications interface 402 receives the removal message and communicates the received removal message to the processor 404. In response to receiving the removal message, the processor 404 removes the alert from a queue of the processor 404 and from the display 406. In one embodiment, the alert management and reporting server may also send the removal message to the first portable communications device 400 in response to not receiving the acknowledgment from the first portable communications device 400 within a predetermined period of time. In this manner, the alert management and reporting server 300 has determined that the caregiver is unavailable to address the substance of the alert. The alert management and reporting server 300 then sends a second message identifying the alert to the n^{th} portable communications device 102 such that a second caregiver is assigned the task associated with the alert. This reassignment process is also applicable when the acknowledgment from the first portable communications device 400 indicates a rejection of the indicated alert. In one embodiment, the removal message is in updated table of active alerts for the first portable communications device 400 wherein the alert removed from the first portable communications device 400 is absent from the updated table of active alerts for the first portable communications device 400.

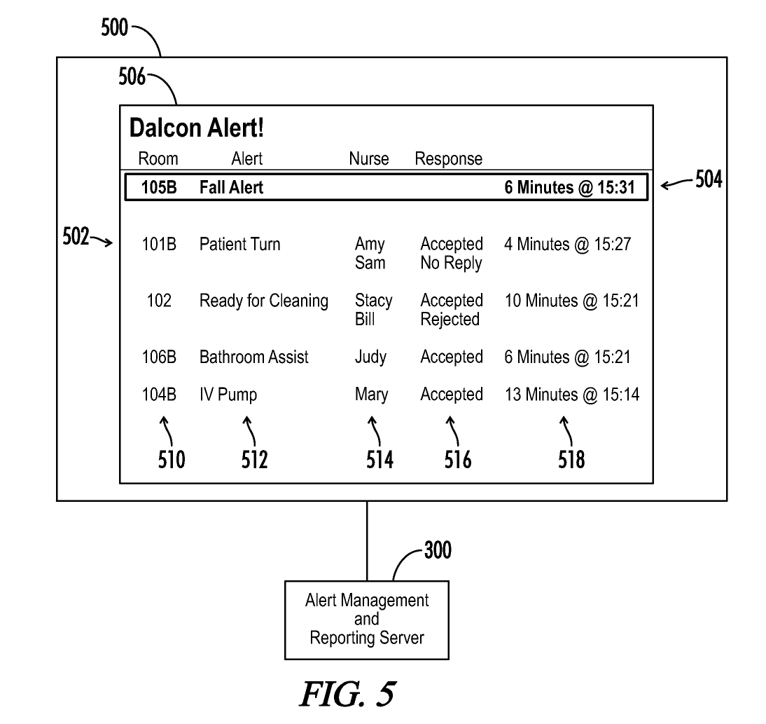

Referring to FIG. 5, the display 500 includes a screen 506 operable to display a dynamic table of active alerts provided to the display 500 by the alert management and reporting server 300. In one embodiment, the screen 506 is mounted on a back wall or a sidewall of a caregiver station such that the screen 506 is viewable to the general public. The dynamic table of active alerts has a plurality of entries, each including a description 512, a location 510, and an elapsed time 518. Each entry may also identify one or more caregivers 514 to which an alert corresponding to the entry has been communicated and their respective responses 516. A first entry 504 of the plurality of entries in the dynamic table of active alerts is an alert corresponding to a patient fall. A patient fall is of an alert type requiring immediate action and the first entry 504 is therefore located at the top of the dynamic table of active alerts and highlighted (i.e., color-coded). Certain types of alerts may just be prioritized for action by caregivers. In the absence of prioritized entries, the alert management and reporting server 300 maintains the oldest active alert at the top of the dynamic table of alerts.

A second entry 502 of the dynamic table of active alerts is a standard alert type. The location 510 of the second entry 502 is shown as room 101B. The description 512 of the second entry 502 is shown as a patient turn. The caregivers 514 notified of the alert corresponding to the second entry 502 are listed as Amy and Sam. The response 516 (i.e., status) provided to the alert management and reporting server 300 by each of the notified caregivers 516 shows that Amy has indicated acceptance of the alert or task via her assigned portable communications device and Sam has not yet indicated acceptance or rejection of the alert or task via his assigned portable communications device. In one embodiment, the status 516 is one of accepted, rejected, or no reply. The elapsed time 518 of the alert corresponding to the second entry 502 is shown as 4 min. at 15:27. The elapsed time 518 corresponds to the elapsed time since the alert corresponding to each entry was: received at the alert management and reporting server 300 of the patient alert management system 100; accepted by a corresponding caregiver; or sent to a portable communications device associated with an appropriate caregiver.

The alert management and reporting server 300 dynamically updates the table of alerts displayed by the display 500 in response to receiving an alert cancellation, receiving an alert from the client computing device 700, receiving an alert from a remote alert monitor, and generating an alert via patient care timers internal to the alert management and reporting server 300. In one embodiment, the alert management and reporting server 300 maintains updates and provides to the display 500 the dynamic table of active alerts. The alert management and reporting server 300 maintains each alert as active until the alert management and reporting server 300 receives an alert cancellation from a remote alert monitor at the location corresponding to the alert.

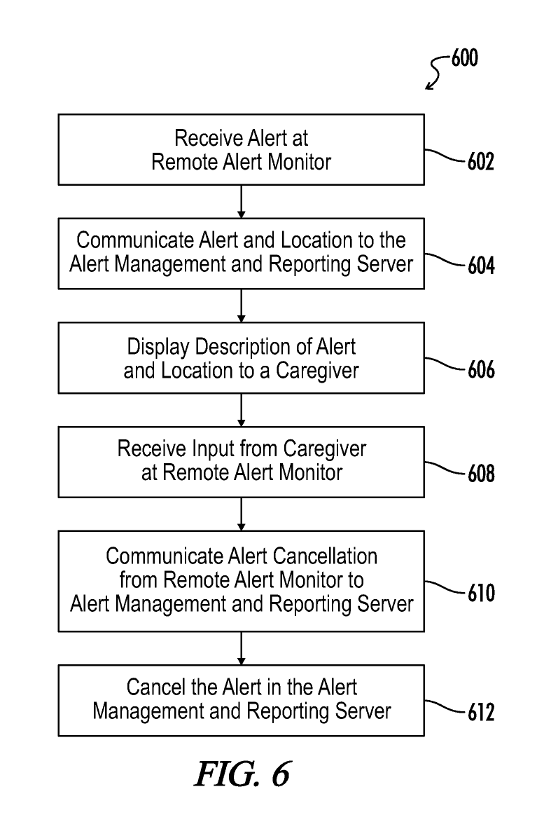

Referring to FIG. 6, a method of managing alerts in the patient alert management system 100 commences at 602 with receiving an alert at the first remote alert monitor 200. At 604, the first remote alert monitor 200 communicates the alert and the location associated with the first remote alert monitor 200 to the alert management and reporting server 300. The alert management and reporting server 300 sends a message to the first portable communications device 400. The first portable communications device 400 displays a description of the alert and the location to a caregiver assigned to the first portable communications device 400 at 606. At 608, the first remote alert monitor 200 receives input from a caregiver (i.e., the caregiver assigned to the first portable communications device 200 or another caregiver) via the user interface 420 of the first portable communications device 200 to cancel the alert. At 610, the first remote alert monitor 200 communicates an alert cancellation to the alert management and reporting server 300 identifying the alert. At 612, the alert management and reporting server 300 cancels the alert in response to receiving the alert cancellation identifying the alert. The alert management and reporting server 300 cancels the alert by identifying the alert is canceled in the memory 302 of the alert management and reporting server 300 and sending a removal message to the first portable communications device 400. In response to receiving the removal message, the first portable communications device 400 removes the description of the alert and location from the display 406 of the first portable communications device 400.

In one embodiment, displaying the description of the alert and the location to a caregiver at 606 includes displaying the description and the location on the display 500 of the patient alert management system 100 in the dynamic table of active alerts provided to the display 500 by the alert management and reporting server 300.

It is contemplated that healthcare staff and caregiver as used herein may include, but are not limited to: nurses, doctors, nurse practitioners, nurse assists, orderlies, janitors, maintenance personnel, or other personnel available at a facility utilizing the patient alert management system 100. It is contemplated that caregiver station as used herein may include, but is not limited to: nurses' station, an admissions station, a secretarial station, a receptionist area, a break room, a nursery, or an information desk. It is also contemplated that a remote alert monitor may be used to queue tasks for personnel at the facility other than tasks strictly limited to patient care. For example, data entry personnel may have a client computing device or a remote alert monitor available to summon appropriate caregivers to provide more information when correcting health records. Such a system may also be beneficial for maintenance personnel to queue maintenance tasks and for janitors to be notified of which rooms need their services.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

1-76. (canceled)

77. A display for use in a patient alert management system comprising:
a screen operable to display a dynamic table of active alerts, the dynamic table of active alerts comprising a plurality of entries, each entry comprising:
a description identifying a cause of an alert corresponding to the entry or an action to be taken in response to the alert corresponding to the entry;
a location associated with the alert corresponding to the entry; and
an elapsed time associated with the entry.

78. The display of claim 77, wherein the elapsed time associated with the entry is the elapsed time since the alert corresponding to the entry was, at least one of:
generated received at an alert management and reporting server of the patient alert management system,
accepted by a caregiver via a portable communications device of the patient alert management system, or
sent to a portable communications device of the patient alert management system by the alert management and reporting server.

79. The display of claim 77, wherein each entry further comprises:
at least one caregiver to which the alert corresponding to the entry is assigned; and
a status of the alert corresponding to the entry with each of the at least one caregivers to which the alert corresponding to the entry is assigned.

80. The display of claim 77, wherein the display dynamically updates the table of alerts in response to receiving at least one of:
an alert cancellation;
an alert from at least one client computing device operable to receive information from health care staff; or
an alert from a remote alert monitor of the patient alert management system.

81. The display of claim 77, wherein an alert management and reporting server updates the dynamic table of alerts to maintain the oldest active alert at a top of the dynamic table of alerts.

82. The display of claim 77, wherein the table of alerts is maintained, updated, and provided to the display by the alert management and reporting server of the patient alert management system.

83. The display of claim 77, wherein at least one entry is color coded based on a type of an alert corresponding to the entry.

84. The display of claim 79, wherein the status of the alert corresponding to the entry is one of: accepted, rejected, or no reply.

85. The display of claim 77, wherein an alert is active until the alert management and reporting server receives an alert cancellation from a remote alert monitor of the patient alert management system at the location corresponding to the alert.

86. The display of claim 77, wherein the screen is mounted on a back wall or side wall of a caregiver station.

87. A patient alert management system comprising:
a remote alert monitor operable to communicate an alert;
an alert management and reporting server operably coupled to the remote alert monitor and operable to receive the alert communicated by the remote alert monitor and to send a message comprising the alert and a location linked to the alert to a portable communications device identifier linked to the location in response to receiving the alert from the remote alert monitor, or at least one client computing device operable to receive information from health care staff; and
a portable communications device operable to:
receive the message sent to the portable communications device identifier;
display the received alert and location to a user of the portable communications device;
receive an acknowledgement from the user; and
communicate the received acknowledgement to the alert management and reporting server.

88. The patient alert management system of claim 87, further comprising a display mounted on a back wall or side wall of a caregiver station, the display and alert management and reporting server cooperatively operable to display a dynamic table of active alerts provided by the alert management and reporting server.

89. A patient alert management system comprising:
a remote alert monitor operable to:
communicate an alert;
receive an alert cancellation from a caregiver at a location of the remote alert monitor, and
communicate the received alert cancellation;
an alert management and reporting server operably coupled to the remote alert monitor, the alert management and reporting server operable to:
receive the alert provided by the remote alert monitor,
send a message comprising the alert and a location linked to the alert to a portable communications device identifier linked to the location in response to receiving the alert from the remote alert monitor,
receive the alert cancellation from the remote alert monitor, and
cancel the alert in response to receiving the alert cancellation from the remote alert monitor; and
a portable communications device operably coupled to the alert management and reporting server, the portable communications device operable to receive the message sent to the portable communications device identifier and to display the received alert and location to a user of the portable communications device.

90. The patient alert management system of claim 89, wherein the portable communications device is further operable to:
receive an acknowledgement from the user;
communicate the received acknowledgement to the alert management and reporting server; and
remove the received alert and location from a display of the portable communications device in response to receiving a removal message from the alert management and reporting server, said removal message sent by the alert management and reporting server in response to receiving an alert cancellation from the remote alert monitor.

91. A method of managing alerts in a patient alert management system that includes a remote alert monitor associated with a location and an alert management and reporting server, the method comprising:
receiving an alert communicated to the remote alert monitor;
communicating the alert and the location from a remote alert monitor to the alert management and reporting server;
displaying a description of the alert and the location associated with the remote alert monitor to a caregiver;
receiving input from the caregiver at the remote alert monitor via a remote alert monitor user interface;
communicating an alert cancellation from the remote alert monitor to the alert management and reporting server in response to receiving the input from the caregiver at the remote alert monitor; and
canceling the alert in the alert management and reporting server in response to receiving the alert cancellation from the remote alert monitor at the alert management and reporting server.

92. The method of claim 91, wherein displaying a description of the alert and the location associated with the remote alert monitor to the caregiver comprises displaying on a display mounted proximate a caregiver station associated with the caregiver a dynamic table of active alerts provided by the alert management and reporting server.

93. The method of claim 91, wherein:
displaying a description of the alert and the location associated with the remote alert monitor to the caregiver comprises:
sending a message comprising the alert and the location associated with the remote alert monitor to a portable communications device associated with a portable communications device identifier linked to the location in the alert management and reporting server in response to receiving the alert from the remote alert monitor;
receiving the message at the portable communications device associated with the portable communications device identifier, the portable communications device operably coupled to the alert management and reporting server; and
displaying a description of the alert and the location to a user of the portable communications device, wherein the user is the caregiver; and
canceling the alert in the alert management and reporting server comprises sending a removal message to the portable communications device from the alert management and reporting server, wherein the portable communications device removes the description of the alert and the location from a display of the portable communications device in response to receiving the removal message.
